(19) United States
(12) Patent Application Publication
(10) Pub. No.: US 2026/0173153 A1
(43) Pub. Date: Jun. 18, 2026

(54) COVERAGE ENHANCEMENT METHOD AND RELATED DEVICES

(71) Applicant: SHENZHEN TCL NEW TECHNOLOGY CO., LTD., Shenzhen, Guangdong (CN)

(72) Inventor: Yiwei DENG, Shenzhen, Guangdong (CN)

(73) Assignee: SHENZHEN TCL NEW TECHNOLOGY CO., LTD., Shenzhen, Guangdong (CN)

(21) Appl. No.: 19/127,102

(22) PCT Filed: Nov. 7, 2022
(86) PCT No.: PCT/CN2022/130400

§ 371 Date: May 2, 2025

(51) Int. Cl. H04W 74/0833

(52) U.S. Cl. CPC H04W 74/0833

(57) ABSTRACT

A coverage enhancement method and related devices are provided. The method, performed by a user equipment (UE), including transmitting multiple Physical Random Access Channel (PRACH) transmissions at RACH occasions (ROs), wherein Synchronization Signal Blocks (SSBs) are mapped to one or more continuous or non-continuous ROs. With this method, better coverage performance is achieved, and the mapping between multiple SSBs and multiple PRACH transmissions is realized.

### TECHNICAL FIELD

The present application relates to wireless communication technologies, and more particularly, to a coverage enhancement method, and related devices such as a user equipment (UE) and a base station (BS) (e.g., a gNB).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by base station knowns as an eNodeB or eNB (evolved NodeB). LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

UE connects to gNB via a random access (RA) procedure, which can be classified into a Contention Free Random Access (CFRA) type and a Contention-based Random Access (CBRA) type. For CFRA, a Preamble is allocated by the gNB and such a preamble is known as dedicated random access preamble. The dedicated preamble may provide to UE via RRC signalling (allocating preamble can be configured within an RRC message). Therefore, the UE can transmit the dedicated preamble without contention. For CBRA, the UE selects a Preamble randomly from a preamble group shared with other UEs. This means that the UE has a potential risk of selecting the same preamble as another UE and subsequently may experience collision. The gNB uses a contention resolution mechanism to handle the access requests. In this procedure, the result is random and not all Random Access succeeds.

The contention-free or contention-based RA procedure can be a four-step (4-step) procedure or a two-step (2-step) procedure. Taking 4-step contention-based RA procedure for example, the UE transmits a contention-based PRACH preamble, also known as MSG1. After detecting the preamble, the gNB responds with a random-access response (RAR), also known as MSG2. The RAR includes an uplink grant for scheduling a PUSCH transmission from the UE known as MSG3. In response to the RAR, the UE transmits MSG3 including an ID for contention resolution. Upon receiving MSG3, the network transmits a contention resolution message, also known as MSG4, with the contention resolution ID. The UE receives MSG4, and if the UE finds its contention-resolution ID it sends an acknowledgement on a PUCCH, which completes the 4-step random access procedure.

The 2-step RA procedure is to reduce latency and control signalling overhead by having a single round trip cycle between the UE and the base station. This is achieved by combining the preamble (MSG1) and the scheduled PUSCH transmission (MSG3) into a single message (MSGA) from the UE to the gNB, known as MSGA and by combining the random-access respond (MSG2) and the contention resolution message (MSG4) into a single message (MSGB) from the gNB to UE. The 2-step procedure and the 4-step procedure can be applied to the CFRA in the case that the dedicated preamble is provided to the UE.

Before performing the 4-step or 2-step RA procedure, UE reads one or more synchronization signal blocks (SSBs) broadcasted by gNB. In NR, each beam transmitted by gNB is associated with a different SSB, and UE selects a certain beam to use to communicate with gNB. Based on the SSB of the selected beam, the UE can then read the system information block (SIB) type 1 (SIB1), which carries cell access related information and supplies the UE with the scheduling of other system information blocks transmitted on the selected beam. When UE sends the very first message of the RA procedure to gNB, it sends a specific pattern called a “preamble” (also referred to as a “RACH preamble,” a “PRACH preamble,” a “sequence”). UE also needs to provide its identity to gNB so that gNB can address it in the next step. This identity is called the random access radio network temporary identity (RA-RNTI) and is determined from the time slot in which the preamble is sent.

Coverage is one of the key factors that an operator considers when commercializing cellular communication networks due to its direct impact on service quality as well as Capital expenditures (CAPEX) and Operating expenses (OPEX). Despite the importance of coverage on the success of NR commercialization, a thorough coverage evaluation and a comparison with legacy Radio Access Technologies (RATs) considering all NR specification details have not been done.

Compared to LTE, NR is designed to operate at much higher frequencies such as 28 GHz or 39 GHz in FR2. Furthermore, many countries are making available more spectrums on FR1, such as 3.5 GHz, which is typically in higher frequencies than for LTE or 3G. Due to the higher frequencies, it is inevitable that the wireless channel will be subject to higher path-loss making it more challenging to maintain an adequate quality of service that is at least equal to that of legacy RATs. One key mobile application of particular importance is voice service for which a typical subscriber will always expect a ubiquitous coverage wherever s/he is.

For FR1, NR can be deployed either in newly allocated spectrums, such as 3.5 GHz, or in a spectrum re-farmed from a legacy network, e.g., 3G and 4G. In either case, coverage will be a critical issue considering the fact that these spectrums will most likely handle key mobile services such as voice and low-rate data services. For FR2, coverage was not thoroughly evaluated during the self-evaluation campaign towards IMT-2020 submission and not considered in Rel-16 enhancements. In these regards, a thorough understanding of NR coverage performance is needed while taking into account the support of latest NR specification.

In Rel-17, PRACH is identified as a bottleneck channel, some companies were proposed multiple PRACH transmissions with the same transmission beam or different beams is SI, e.g., mechanism on triggering/initiating multiple PRACH transmissions, determination of number of transmissions and transmission pattern, differentiation between enhanced UE and legacy UE and possible collision handling between PRACH transmission with and without multiple PRACH transmissions. Unfortunately, due to time limitation, PRACH enhancement was not standard. Potential methods of PRACH enhancement were proposed by some companies and feature leader only, details were not discussed. In previous RAN1 meeting, some issue for multiple PRACH transmissions with same beam or different beams has been discussed and several agreements has been achieved, e.g., multiple PRACH transmissions in one PRACH attempt with the same PRACH preamble with the same beam, multiple PRACH transmissions are based on time domain resources of RACH occasions (ROs) used for the case of same beam. One or multiple RAR windows are used; however, details have not been given yet. The details of the agreements are shown below:

### Agreement

For multiple PRACH transmissions with same beam, at least support to use same PRACH preamble during the multiple PRACH transmissions in one RACH attempt.
   FFS: whether different preambles can be utilized in different PRACH transmissions during the multiple PRACH transmissions in one RACH attempt.

### Agreement

For multiple PRACH transmissions with same beam, at least ROs located at different time instances can be utilized for the transmissions.
   FFS: whether/how the starting RB of ROs can be different at different time instances for multiple PRACH transmissions.
   FFS: whether/how multiple PRACH transmissions located in the same time instance, e.g., for UEs with multiple Tx chains.

### Agreement

For multiple PRACH transmissions with same beam, for RAR monitoring, consider the following options.
Option 1: One RAR window per each PRACH transmission, the RAR window follows the legacy design.
   FFS: RA-RNTI.
Option 2: Only one RAR window for all of the multiple PRACH transmissions.
   FFS: the start position of the RAR window.
   FFS: RA-RNTI.

In RAN #94 meeting, a new Rel-18 work item on NR coverage enhancements was approved. The objective of this work item is to study potential coverage enhancement solutions for PRACH and waveform for both FR1 and FR2. The detailed objectives are as follows.
Specify following PRACH coverage enhancements (RAN1, RAN2)
   Multiple PRACH transmissions with same beams for 4-step RACH procedure
   Study, and if justified, specify PRACH transmissions with different beams for 4-step RACH procedure
   Note 1: The enhancements of PRACH are targeting for FR2, and can also apply to FR1 when applicable.
   Note 2: The enhancements of PRACH are targeting short PRACH formats, and can also apply to other formats when applicable.
Study and if necessary specify following power domain enhancements
   Enhancements to realize increasing UE power high limit for CA and DC based on Rel-17 RAN4 work on “Increasing UE power high limit for CA and DC”, in compliance with relevant regulations
      Note 1: The study starts after RAN4 work on “Increasing UE power high limit for CA and DC” is done depending on conclusions from RAN4.
      Note 2: The objective will be revisited and further clarified in RAN plenary after RAN4 work on “Increasing UE power high limit for CA and DC” is done, and the discussion in WGs will not start before the objective is revised with a clearer scope.
      Note 3: Both RAN1 and RAN4 are expected to be involved; to decide the order of either (RAN4, RAN1) or (RAN1, RAN4) later.
   Enhancements to reduce MPR/PAR, including frequency domain spectrum shaping with and without spectrum extension for DFT-S-OFDM and tone reservation
Specify enhancements to support dynamic switching between DFT-S-OFDM and CP-OFDM

Some potential methods for coverage enhancement have been discussed in previous RAN1 meetings; however, there are still some issues that need to be enhanced. This invention relates to wireless communication systems, especially for coverage enhancement for uplink (UL) transmission.

### SUMMARY

The objective of the present application is to provide a coverage enhancement method and related devices, for achieving better coverage.

In a first aspect, an embodiment of the present application provides a coverage enhancement method, performed by a user equipment (UE), the method including: transmitting multiple Physical Random Access Channel (PRACH) transmissions at RACH occasions (ROs), wherein Synchronization Signal Block (SSBs) are mapped to one or more continuous or non-continuous ROs.

In a second aspect, an embodiment of the present application provides a coverage enhancement method, performed by base station (BS), the method including: receiving from a user equipment (UE) multiple Physical Random Access Channel (PRACH) transmissions at RACH occasions (ROs), wherein Synchronization Signal Block (SSBs) are mapped to one or more continuous or non-continuous ROs.

In a third aspect, an embodiment of the present application provides a UE, including a processor, configured to call and run program instructions stored in a memory, to execute the method of the first aspect.

In a fourth aspect, an embodiment of the present application provides a BS, including a processor, configured to call and run program instructions stored in a memory, to execute the method of the second aspect.

In a fifth aspect, an embodiment of the present application provides a computer readable storage medium provided for storing a computer program, which enables a computer to execute the method of any of the first and the second aspects.

In a sixth aspect, an embodiment of the present application provides a computer program product, which includes computer program instructions enabling a computer to execute the method of any of the first and the second aspects.

In a seventh aspect, an embodiment of the present application provides a computer program, when running on a computer, enabling the computer to execute the method of any of the first and the second aspects.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a block diagram of a user equipment and a base station of wireless communication in a communication controlling system according to an embodiment of the present disclosure.

FIG. 2 is a schematic diagram illustrating radio protocol architecture within gNB and UE.

FIG. 3 is a schematic diagram illustrating a gNB further including a centralized unit (CU) and a plurality of distributed unit (DUs).

FIG. 4 is a flowchart of a coverage enhancement method according to a first embodiment of the present application.

FIG. 5 is a schematic diagram illustrating an exemplary mapping between SSBs and ROs based on time according to an embodiment of the present application.

FIG. 6 is a schematic diagram illustrating an exemplary mapping between SSBs and ROs based on time and frequency according to an embodiment of the present application.

FIG. 7 is a schematic diagram illustrating another exemplary mapping between SSBs and ROs based on time and frequency according to an embodiment of the present application.

FIG. 8 is a flowchart of a coverage enhancement method according to a second embodiment of the present application.

FIG. 9 is a flowchart of a coverage enhancement method according to a third embodiment of the present application.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

In 3GPP Rel-17, PRACH coverage enhancement has not been addressed, despite being identified as one of the bottleneck channels in corresponding studies. PRACH transmission is very important for many procedures, e.g., initial access and beam failure recovery. To achieve better coverage performance, some enhancement methods will be needed. This disclosure proposes some coverage enhancement methods for PRACH channel. With these methods, a better coverage will be achieved.

Multiple PRACH transmissions with the same beam for 4-step RACH was approved in 3GPP RAN #94 meeting. However, in current 3GPP specification, a Random Access Channel (RACH) occasion (RO) is indicated by system information block1 (SIB1), and a RACH sequence only occupies a RACH occasion for transmission and does not repeat. Thus, how to indicate the PRACH transmission with repetitions should be determined. Moreover, the relationship between RACH repetition transmission occasions and beam indexes should also be determined.

Above all, how does the SSB map to the ROs? In addition, the relationship between SSB and RACH preambles should also be determined (i.e., the index of the RO should be determined when SSB maps to ROs).

Similar to Msg3 repetition request, it is important to have criteria for using PRACH repetition, in order to avoid excessive usage of this option by UEs (which may result in excessive congestion of resources). Because the need for PRACH repetition is linked to the coverage situation of the UE, some criteria similar to what was used for Msg3 repetition request (i.e., based on a configured threshold on SS-RSRP) can be useful for triggering PRACH repetition.

These criteria can also depend on UE power class because the final reception power of PRACH depends both on the path loss (which is related to SS-RSRP) and the UL Tx power. So the number of Msg3 repetitions can be built a link to multiple PRACH. In addition, in the current 5G NR specification, usage of DFT-S-OFDM waveform is indicated via an RRC parameter called tmnsformPrecoder. Switching to DFT-S-OFDM and back to CP-OFDM scheme requires RRC reconfiguration of relevant parameters. There are 4 different RRC parameters that are related to (or involved in) enabling/disabling transform precoding for different modes/types of PUSCH scheduling:
transformPrecoder in pusch-Config
transformPrecoder in configuredGrantConfig
msg3-transformPrecoder
msgA-TransformPrecoder-r16

However, DFT-S-OFDM waveform is beneficial for UL coverage limited scenario because of its lower Peak-to-Average Power Ratio (PAPR) compared with CP-OFDM waveform. Currently, UL waveform is configured via RRC and this limitation imposes a large barrier to switch over to DFT-S-OFDM waveform for cell-edge UEs practically.

Above all, what the relationship between Msg3 transmission and the multiple PRACH transmissions will be? In addition, is it possible that the waveform of Msg3 is determined by the multiple PRACH transmissions implicitly?

In current 3GPP specification, the UE starts the ra-Response Window configured in RACH-ConfigCommon at the first PDCCH occasion (means first symbol of the earliest CORESET the UE is configured to receive PDCCH for Type1-PDCCH CSS set) from the end of the Random Access Preamble transmission. When PRACH repetition is enabled, if the ra-ResponseWindow is started at the first PDCCH occasion from the end of the first PRACH repetition transmission occasion, then, the UE needs to receive RAR during the PRACH repetition. In addition, the end of the ra-ResponseWindow also needs to be determined, e.g., based on the size of ra-ResponseWindow or based on both the size of ra-responsedWindow and the number of PRACH repetitions. Thus, how to determine the ra-ResponseWindow needs to be studied, including the start of ra-ResponseWindow and the size of the ra-ResponseWindow.

Above all, the associated issues about the RAR should be determined, e.g., RAR window size, start of RAR, RA-RNTI calculated.

The invention of this disclosure can be summarized as follows:

This disclosure proposes method(s) to determine the relationship between SSBs and multiple PRACH transmission occasions, wherein a SSB can be mapped to multiple continuous/non-continuous time domain based or frequency domain based ROs.
Time based mechanism can be used for a SSB to map to continuous or non-continuous Ros. One SSB is associated to multiple Ros. When UE transmits PRACH over the ROs, a corresponding SSB is indicated.
A mechanism based on the combination of time and frequency can be used for a SSB to map to continuous or non-continuous ROs, a set of time domain resources first (the set can be configured or pre-defined), then the first time domain resources with different frequency resources, then a remaining set of time domain resources.

This disclosure proposes method(s) to determine the relationship between multiple PRACH transmissions and other transmissions (e.g., Msg3, or HARQ-ACK for Msg4).
When multiple PRACH transmissions are enabled, the Msg3 or HARQ-ACK for Msg4 repetitions are also triggered. The number of repetitions for Msg3 or HARQ-ACK for Msg4 is related to the number of the multiple PRACH transmissions.
When multiple PRACH transmissions are enabled, the transmission power boosting of Msg3 or HARQ-ACK for Msg4 repetitions is also triggered. The transmission power boosting value for repetitions of Msg3 or HARQ-ACK for Msg4 is related to the number of multiple PRACH transmissions.
The waveform for Msg3 transmission is related to the multiple PRACH transmissions.

This disclosure proposes method(s) for RAR window and RA-RNTI when multiple PRACH transmissions with the same or multiple beams for RACH are enabled. One or more RAR windows and one or more RA-RNTIs can be determined.
Multiple RAR windows can be configured. The number of RAR windows is associated with the number of beams of multiple PRACH transmissions. In other words, when multiple PRACH transmissions with multiple beams are enabled, one RAR window is triggered after each beam. The beams may be associated to one or more PRACH transmissions.
Multiple RAR windows can be determined. The number of RAR windows is associated with a set of ROs of multiple PRACH transmission. In other words, when multiple PRACH transmissions with same or multiple beams are enabled, one RAR window is triggered after each set of ROs.
A single RAR window can be determined. Only a single RAR window can be triggered for multiple PRACH transmissions.

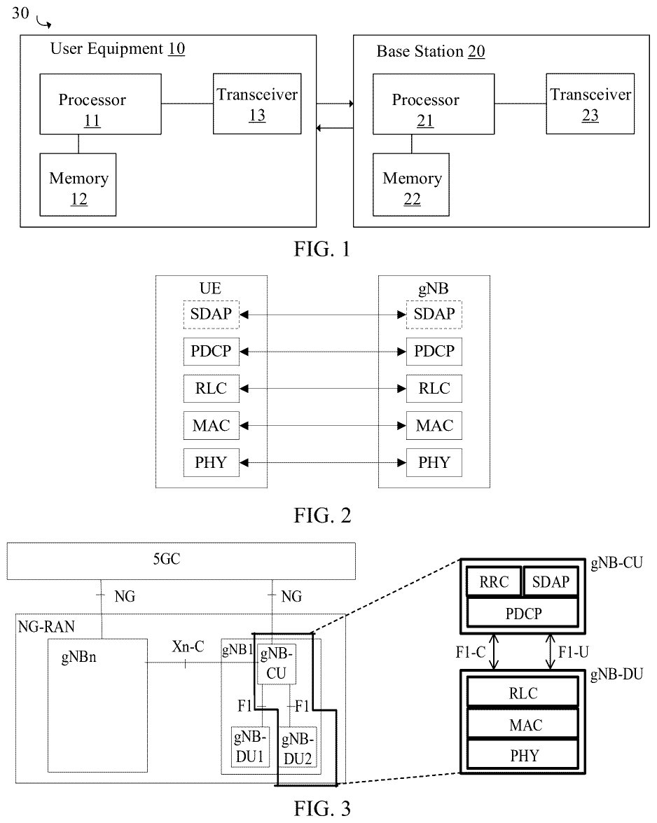

FIG. 1 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art. The user plane radio protocol architecture within the gNB and UE is shown in FIG. 2, which includes optional Service Data Adaptation Protocol (SDAP), Packet Data Convergence Protocol (PDCP), Radio Link Control (RLC), Medium Access Control (MAC). In RAN functional split, a gNB further includes a centralized unit (CU) and a plurality of distributed unit (DUs) as shown in FIG. 3. The protocol stack of CU includes an RRC layer, an optional SDAP layer, and a PDCP layer, while the protocol stack of DU includes an RLC layer, a MAC layer, and a PHY layer. The F1 interface between the CU and DU is established between the PDCP layer and the RLC layer.

This disclosure proposes method(s) to determine the relationship between SSBs and multiple PRACH transmission occasions. A SSB can be mapped to multiple continuous/non-continuous time domain based or frequency domain based RACH occasions (ROs). In current 3GPP specification, for RACH access procedure, the beam information is carried by RACH occasion and there are one-to-one, one-to-multiple, multiple-to-one relationships between SSB and ROs. Similarly, when the PRACH repetition transmission is enabled, the current relationship between SSB and ROs needs to be modified. The fundamental principle to determine the relationship between SSB and ROs is to use same beam index for all PRACH repetitions, and in some cases, multiple SSBs can be mapped to PRACH repetitions each SSB associated with more than one ROs. In addition, the index of a RO can be determined based on time first based mechanism, or time and frequency based mechanism, or time and frequency and sequence of a RACH combination based mechanism. The following methods to determine the relationship between SSBs and multiple PRACH repetition transmission occasions can be considered.

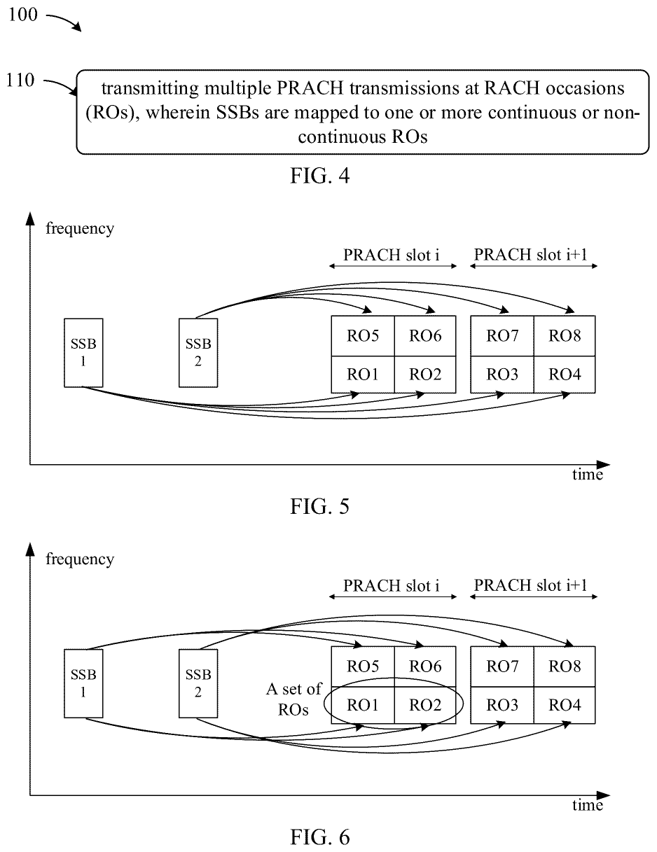

FIG. 4 illustrates a coverage enhancement method according to a first embodiment of the present application. Referring to FIG. 4 in conjunction with FIG. 1, the method 100 includes the followings. In Step 110, UE transmits multiple Physical Random Access Channel (PRACH) transmissions (i.e., PRACH repetitions) at RACH occasions (ROs), wherein Synchronization Signal Blocks (SSBs) are mapped to one or more continuous or non-continuous ROs. The continuous ROs or non-continuous may span one or more slots or subframes. The continuous ROs may means the ROs are on different time instances and all the ROs are valid or available. With this method, better coverage performance is achieved, and the mapping between multiple SSBs and multiple PRACH transmissions is realized.

In an embodiment, a time based mechanism is used for the SSB to map to continuous or non-continuous ROs, and the SSB is associated to multiple ROs in the time domain. More specifically, the SSB maps to the ROs with same frequency resources and different time domain resources and spans all the time domain resources within a PRACH periodicity. In another embodiment, a time and frequency based mechanism is used for the SSB to map to continuous or non-continuous ROs in the following order: a set of time domain resources first, then different frequency resources corresponding to the set of time domain resources, then a remaining set of time domain resources. 6. The method of claim 1, wherein RO index is determined based on a time first based mechanism, or a time and frequency based mechanism, or a mechanism based on time, frequency and RACH sequence.

In an embodiment, RO index is in an order complying with at least one of followings: the order increases based on time resources within a PRACH slot; the order increases based on multiple PRACH slots; the order increases based on frequency multiplexed RACH occasions; the order increases based on time resources within a set of PRACH slots; the order increases based on frequency corresponding to a set of time resources within a set of PRACH slots; the order increases based on the time resources within a remaining set of PRACH slots; or the order increases based on frequency corresponding to a remaining set of time resources within a remaining set of PRACH slots.

In an embodiment, each consecutive number of N preamble indexes is established for a RO in a PRACH slot or a set of PRACH slots. The ROs are characterized by at least one of the followings: an increasing order of preamble indexes within a single RACH occasion; an increasing order of time resources indexes for time multiplexed ROs within a PRACH slot; an increasing order of time resources indexes for time multiplexed ROs in multiple PRACH slots; an increasing order of time resources indexes for time multiplexed ROs within a set of PRACH slots; an increasing order of time resources indexes for time multiplexed ROs within a remaining set of PRACH slots; an increasing order of frequency resources indexes for frequency multiplexed ROs; an increasing order of frequency resources indexes for frequency multiplexed ROs within a set of PRACH slots; or an increasing order of frequency resources indexes for frequency multiplexed ROs within a remaining set of PRACH slots.

Further details on how to determine the relationship between SSBs and multiple PRACH repetition transmission occasions are described as follows.

For the scenario the ROs for multiple PRACH transmissions are independent from the single PRACH transmission (legacy PRACH), which means the ROs for multiple PRACH transmissions are configured specifically, the ROs for multiple PRACH transmission are only used for more than one PRACH transmissions (repetitions).

In a first possible implementation, time based mechanism can be used for a SSB to map to continuous or non-continuous ROs. A SSB is associated to multiple ROs. When UE transmits PRACH over the ROs, it means the corresponding SSB is indicated. For instance, as shown in FIG. 5, it is assumed there are 2 SSBs in total, denoted as SSB1 and SSB2, and the total number of ROs for multiple PRACH transmissions is configured as 8, denoted as {RO1, RO2, RO3, RO4, RO5, RO6, RO7, RO8}. Then, SSB1 maps to {RO1, RO2, RO3, RO4}, where the set of ROs are on different time instances, and the SSB 2 maps to {RO5, RO6, RO7, RO8}, where the set of ROs are also on different time instances. In some embodiments, the continuous ROs means the ROs are on different time instances and all of the ROs within the set are valid or available. In some embodiments, the continuous ROs can span one or more slots or subframes. The RO mapping is back-to-backed (or one by one) or non back-to-backed (or not one by one). In some embodiments, a SSB with the lowest index maps to the ROs with same frequency resources and different time domain resources and spans all of the time domain resources within a PRACH periodicity.

In some embodiments, the RO index may be in an order complying with followings:
First: the order increases based on the time resources within a PRACH slot;
Second: the order increases based on the multiple PRACH slots;
Third: the order increases based on the frequency multiplexed RACH occasions.

In some embodiments, each consecutive number of N preamble indexes is established for a RO in a PRACH slot.
First: in an increasing order of preamble indexes within a single RACH occasion;
Second: in an increasing order of time resources indexes for time multiplexed ROs within a PRACH slot;
Third: in an increasing order of frequency resources indexes for frequency multiplexed ROs.

In some embodiments, each consecutive number of N preamble indexes is established for a RO in a set of PRACH slots.
First: in an increasing order of preamble indexes within a single RACH occasion;
Second: in an increasing order of time resources indexes for time multiplexed ROs within a PRACH slot;
Third: in an increasing order of time resources indexes for time multiplexed ROs in multiple PRACH slots;
Fourth: in an increasing order of frequency resources indexes for frequency multiplexed ROs.

In some cases, the mapping relationship (association) between SSBs and ROs is one-to-one, which means a SSB is associated with a RO. In this case, the SSB information is indicated by the first RO within the ROs for multiple PRACH transmissions.

In some cases, the mapping relationship (association) between SSBs and ROs is multiple-to-one, which means multiple SSBs is associated with a RO. In this case, the SSB information is indicated by the first RACH sequence for multiple PRACH transmissions.

In a second possible implementation, time and frequency based mechanism can be used for a SSB to map to continuous or non-continuous ROs, a set of time domain resources first (the set can be configured or pre-defined), then the first time domain resources with different frequency resources, then a remaining set of time domain resources. For instance, as shown in FIG. 6. it is assumed there are total 2 SSBs, denoted as SSB1 and SSB2, and the total number of ROs for multiple PRACH transmission is configured as 8, denoted as {RO1, RO2, RO3, RO4, RO5, RO6, RO7, RO8}. Then, SSB 1 maps to {RO1, RO2, RO5, RO6}, where the set of the ROs are on different time instances, and the SSB2 maps to {RO3, RO4, RO7, RO8}, where the set of the ROs are also on different time instances.

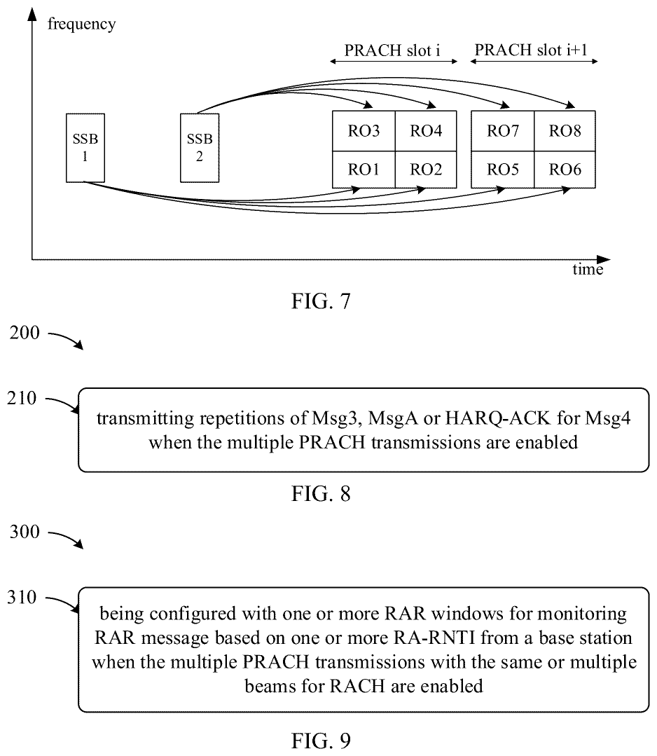

For another instance, as shown in FIG. 7, it is assumed there are total 2 SSBs, denoted as SSB1 and SSB2, and the total number of ROs for multiple PRACH transmission is configured as 8, denoted as {RO1, RO2, RO3, RO4, RO5, RO6, RO7, RO8}. Then SSB 1 maps to {RO1, RO2, RO5, RO6}, where the set of the ROs are on different time instances, and the SSB2 maps to {RO3, RO4, RO7, RO8}, where the set of the ROs are also on different time instances.

In some embodiments, the continuous ROs means the ROs are on different time instances and all of the ROs within the set are valid or available. In some embodiments, the continuous ROs can span one or more slots or subframes. The RO mapping is back-to-backed (or one by one) or non back-to-backed (or not one by one).

In some cases, the mapping relationship (association) between SSBs and ROs is one-to-one, which means a SSB is associated with a RO. In this case, the SSB information is indicated by the first RO within the ROs for multiple PRACH transmissions.

In some cases, the mapping relationship (association) between SSBs and ROs is multiple-to-one, which means multiple SSB is associated with a RO. In this case, the SSB information is indicated by the first RACH sequence for multiple PRACH transmissions.

In some embodiments, the RO index may be in an order complying with followings:
First: the order increases based on the time resources within a PRACH slot;
Second: the order increases based on the multiple PRACH slots;
Third: the order increases based on the frequency multiplexed RACH occasions.

In some embodiments, each consecutive number of N preamble indexes is established for a RO in a PRACH slot.
First: in an increasing order of preamble indexes within a single RACH occasion;
Second: in an increasing order of time resources indexes for time multiplexed ROs within a PRACH slots;
Third: in an increasing order of frequency resources indexes for frequency multiplexed ROs.

In some embodiments, each consecutive number of N preamble indexes is established for a RO in a set of PRACH slots.
First: in an increasing order of preamble indexes within a single RACH occasion;
Second: in an increasing order of time resources indexes for time multiplexed ROs within a PRACH slot;
Third: in an increasing order of time resources indexes for time multiplexed ROs in multiple PRACH slots;
Fourth: in an increasing order of frequency resources indexes for frequency multiplexed ROs.

In some embodiments, the RO index may be in an order complying with followings:
First: the order increases based on the time resources within a set of PRACH slots;
Second: the order increases based on the frequency of the time resources set, wherein the time resources set is determined based on first step;
Third: the order increases based on the time resources within a remaining set of PRACH slots;
Fourth: the order increases based on the frequency of the time resources set, wherein the time resources set in determined based on the first step.

In some embodiments, each consecutive number of N preamble indexes is established for a RO in a PRACH slot.
First: in an increasing order of preamble indexes within a single RACH occasion;
Second: in an increasing order of time resources indexes for time multiplexed ROs within a set of PRACH slots;
Third: in an increasing order of frequency resources indexes for frequency multiplexed ROs within the set of PRACH slots;
Fourth: in an increasing order of time resources indexes for time multiplexed ROs within a remaining set of PRACH slots;
Fifth: in an increasing order of frequency resources indexes for frequency multiplexed ROs within the remaining set of PRACH slots.

If the set of PRACH slots is more than 2, the order is determined based on the above 3 and/or 4 and/or 5 step in cycles.

This disclosure proposes method(s) to determine the relationship between multiple PRACH transmissions and others transmissions (e.g., Msg3, or HARQ-ACK for Msg4). Similar to Msg3 repetition request, it is important to have criteria for using PRACH repetition, in order to avoid excessive usage of this option by UEs (which can result in excessive congestion of resources). Because the need for PRACH repetition is linked to the coverage situation of the UE, when multiple PRACH transmissions for a UE are enabled, it's means the UE is with poor coverage link. Similarly, the Msg3 and HARQ-ACK for Msg4 transmission are also under coverage poor link. So when multiple PRACH transmissions are enabled, some parameters or some mechanisms for multiple PRACH transmission transmissions can also be used for Msg3 and HARQ-ACK for Msg4. The following methods can be considered.

FIG. 8 illustrates a coverage enhancement method according to a second embodiment of the present application. Referring to FIG. 8 in conjunction with FIG. 1, the method 200 includes the followings. In Step 210, UE transmits repetitions of Msg3, MsgA or Hybrid Automatic Repeat reQuest Acknowledgement (HARQ-ACK) for Msg4 when multiple PRACH transmissions are enabled. With this method, better coverage performance is achieved, and determination on the relationship between multiple PRACH transmissions and other transmissions (e.g., Msg3, or HARQ-ACK for Msg4) is realized.

In an embodiment, the number of repetitions for Msg3 or HARQ-ACK for Msg4 is related to the number of the multiple PRACH transmissions. In an exemplary example, the number of repetitions of Msg3 or HARQ-ACK for Msg4 is equal to the number of the multiple PRACH transmissions. In another exemplary example, the number of repetitions of Msg3 or HARQ-ACK for Msg4 is equal to the number of the multiple PRACH transmissions plus a delta value. In still another exemplary example, the relationship between the number of repetitions of Msg3 or HARQ-ACK for Msg4 and the number of the multiple PRACH transmissions is determined by a table. More specifically, for a specific PRACH format, the actual number of repetitions of Msg3 or HARQ-ACK for Msg4 is equal to the number of the multiple PRACH transmissions plus a corresponding delta value.

In an embodiment, transmission power boosting for the repetitions of Msg3 or HARQ-ACK for Msg4 is triggered, and a transmission power boosting value for the repetitions of Msg3 or HARQ-ACK for Msg4 is related to the number of the multiple PRACH transmissions.

In an embodiment, waveform for Msg3 or MsgA transmission is related to the multiple PRACH transmissions. For example, when the number of the multiple PRACH transmissions is larger than 1, the waveform of subsequent Msg3 or MsgA transmission is DFT-S-OFDM; and when the number of the multiple PRACH transmissions is equal to 1, the waveform of subsequent Msg3 transmission is based on configuration.

Further details on how to determine the relationship between multiple PRACH transmissions and others transmissions (e.g., Msg3, or HARQ-ACK for Msg4) are described as follows.

In a first possible implementation, when multiple PRACH transmissions are enabled, the Msg3 or HARQ-ACK for Msg4 repetitions are also triggered, the number of repetitions for Msg3 or HARQ-ACK for Msg4 is related to the number of multiple PRACH transmissions.

For msg3 or HARQ-ACK for Msg4 repetitions, the number of repetitions can be determined at least one of the followings or a combination of the following alternatives.
The number of repetitions of Msg3 or HARQ-ACK for Msg4 is equal to the number of multiple PRACH transmissions.
The number of repetitions of Msg3 or HARQ-ACK for Msg4 is equal to the number of multiple PRACH transmissions plus a delta value, the delta value can be pre-defined or configured.
The number of repetitions of Msg3 or HARQ-ACK for Msg4 is related to the number of multiple PRACH transmissions. The relationship between Msg3 or HARQ-ACK for Msg4 and multiple PRACH transmissions can be determined by a table, wherein the table can be configured or pre-defined, as shown in table 1. For one of the multiple PRACH transmissions with a PRACH format, then the actual number of repetitions of Msg3 or HARQ-ACK for Msg4 is equal to: the number of multiple PRACH transmissions+corresponding delta value.

TABLE 1
Relationship between multiple PRACH transmission
and Msg3 or HARQ-ACK for Msg4

| | PRACH | Number of multiple | Delta value for Msg3 or |
|---|---|---|---|
| Index | format | PRACH transmission | HARQ-ACK for Msg4 |
| 0 | Format x_1 | 2 | 0 |
| 1 | Format x_2 | 4 | 2 |
| 2 | Format x_3 | 2 | 2 |
| . . . | . . . | 4 | 4 |
| N | Format x_N | 2 | 4 |

In a second possible implementation, when multiple PRACH transmissions are enabled, the transmission power boosting of Msg3 or HARQ-ACK for Msg4 repetitions is also triggered. The transmission power boosting value for the repetitions of Msg3 or HARQ-ACK for Msg4 is related to the number of the multiple PRACH transmissions.

In a third possible implementation, the waveform for Msg3/MsgA transmission is related to the multiple PRACH transmissions. When the number of multiple PRACH transmissions is larger than 1, the waveform of subsequent Msg3 transmission is DFT-S-OFDM, and the UE ignores the configuration of the msg3-transformPrecoder parameter. When the number of multiple PRACH transmissions is equal to 1, the waveform of subsequent Msg3 transmission is based on the configuration of the msg3-transformPrecoder parameter. In some embodiments, the same mechanism and/or value can be reused for MsgA transmission. When the number of multiple PRACH transmissions is larger than 1, the waveform of subsequent MsgA transmission is DFT-S-OFDM, and the UE ignores the configuration of the msgA-transformPrecoder parameter. When the number of multiple PRACH transmissions is equal to 1, the waveform of the subsequent MsgA transmission is based on the configuration of the msgA-transformPrecoder parameter.

This disclosure proposes method(s) for RAR window and RA-RNTI when multiple PRACH transmissions with the same or multiple beams for RACH are enabled. One or more RAR windows and one or more RA-RNTIs can be determined. In current 3GPP specification, the UE starts the ra-ResponseWindow configured in RACH-ConfigCommon at the first PDCCH occasion (first symbol of the earliest CORESET the UE is configured to receive PDCCH for Type1-PDCCH CSS set) from the end of the Random Access Preamble transmission. When PRACH repetition is enabled, if the ra-ResponseWindow is started at the the first PDCCH occasion from the end of the first PRACH repetition transmission occasion, then, the UE needs to receive RAR during the PRACH repetition. In addition, the end of the ra-ResponseWindow also needs to be determined, e.g. based on the size of ra-ResponseWindow or based on both the size of ra-responsedWindow and the number of PRACH repetitions. Thus, how to determine the ra-ResponseWindow needs to be studied, including the start of ra-ResponseWindow and the size of the ra-ResponseWindow. The following methods can be considered.

FIG. 9 illustrates a coverage enhancement method according to a third embodiment of the present application. Referring to FIG. 9 in conjunction with FIG. 1, the method 300 includes the followings. In Step 310, UE is configured by a base station (BS) with one or more random access response (RAR) windows (e.g., ra-ResponseWindow) for monitoring RAR message based on one or more Random Access Radio Network Temporary Identifier (RA-RNTI) from the base station when multiple PRACH transmissions with the same or multiple beams for RACH are enabled. With this method, better coverage performance is achieved, and determination on the start and the size of random access response window is realized.

In an embodiment, multiple RAR windows are configured, and the number of the RAR windows is associated with the number of beams of the multiple PRACH transmissions. In an exemplary example, one RAR window is triggered after the last RO of a beam. In another embodiment, multiple RAR windows are determined, and the number of the RAR windows is associated with the number of sets of RACH occasions (ROs) of the multiple PRACH transmissions. In an exemplary example, one RAR window is triggered after each set of ROs. For the cases of multiple RAR windows, a start of each RAR window may be based on a first RO or a first actual RO with PRACH transmission.

In still another embodiment, only a single RAR window is triggered for the multiple PRACH transmissions. For the case of single RAR window, a start of the RAR window may be based on a first RO or a last RO or a first actual RO or a last actual RO or any RO within the multiple PRACH transmissions.

In an embodiment, RA-RNTI is determined based on a first RO within the multiple PRACH transmissions. In another embodiment, RA-RNTI is determined based on a last RO within the multiple PRACH transmissions. In still another embodiment, RA-RNTI is determined based on a combination of all ROs or all actual ROs or a set of ROs or a set of actual ROs of the multiple PRACH transmissions.

Further details on how to determine RAR windows and RA-RNTI when multiple PRACH transmissions with the same or multiple beams for RACH are enabled are described as follows.

In a first possible implementation, multiple RAR windows can be configured. The number of RAR windows is associated with the number of beams of multiple PRACH transmissions. In other words, when multiple PRACH transmissions with multiple beams are enabled, a RAR window is triggered after each of the beams. The beams may be associated to one or more PRACH transmissions. In some embodiments, the starting of each RAR window is based on the first or the first actual RO with PRACH transmission. In addition, the RAR window size can be indicated by gNB directly or can be determined based on the size of ra-ResponseWindow and a variable value, wherein the variable value is determined based on the ROs within multiple PRACH transmissions.

In a second possible implementation, multiple RAR windows can be determined. The number of RAR windows is associated with a set of ROs of the multiple PRACH transmissions. In other words, when multiple PRACH transmissions with same or multiple beams are enabled, a RAR window is triggered after each set of ROs. In some embodiments, the starting of each RAR window is based on the first or the first actual RO with PRACH transmission. In addition, the RAR window size can be indicated by gNB directly or can be determined based on size of ra-ResponseWindow and a variable value, wherein the variable value is determined based on the ROs within multiple PRACH transmissions.

In a third possible implementation, a single RAR window can be determined. Only a single RAR window can be triggered for the multiple PRACH transmissions. In some embodiments, the starting of the RAR window is based on the first or the last or the first actual or the last actual or any one RO within the multiple PRACH transmissions. In addition, the RAR window size can be indicated by gNB directly or can be determined based on the size of ra-ResponseWindow and a variable value (e.g. the size of ra-ResponseWindow plus the variable value), wherein the variable value is determined based on the ROs within the multiple PRACH transmissions. In some examples, the RO is a remaining RO from a reference RO for determining the start of RAR window to the end of ROs within the multiple PRACH transmissions.

In some embodiments, the RA-RNTI is determined based on the first RO within the multiple PRACH transmissions. In some embodiments, the RA-RNTI is determined based on the last RO within the multiple PRACH transmissions. In some embodiments, the RA-RNTI is determined based on the middle of ROs within the multiple PRACH transmissions. In some embodiments, the RA-RNTI is determined based on the combination of all the ROs of the multiple PRACH transmissions. In some embodiments, the RA-RNTI is determined based on the combination of all the actual ROs of the multiple PRACH transmissions. In some embodiments, the RA-RNTI is determined based on the combination of the first RO and the last RO within the multiple PRACH transmissions. In some embodiments, the RA-RNTI is determined based on the combination of the first actual RO and the last actual RO within the multiple PRACH transmissions. In some embodiments, the RA-RNTI is determined based on the combination of a set of ROs and a PRACH preamble sequence. In some embodiments, multiple RA-RNTI can be determined based on more than one ROs, wherein each RO can be used for determining a RA-RNTI.

Commercial interests for some embodiments are as follows. 1. Solving issues in the prior art. 2. Carrying out coverage enhancement. 3. Achieving better coverage performance. 4. Realizing mapping between multiple SSBs and multiple PRACH transmissions. 5. Realizing determination on the relationship between multiple PRACH transmissions and other transmissions (e.g., Msg3, or HARQ-ACK for Msg4). 6. Realizing determination on the start and the size of random access response window. 7. Providing a good communication performance. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

The embodiment of the present application further provides a computer readable storage medium for storing a computer program. The computer readable storage medium enables a computer to execute corresponding processes implemented by the UE/BS in each of the methods of the embodiment of the present application. For brevity, details will not be described herein again.

The embodiment of the present application further provides a computer program product including computer program instructions. The computer program product enables a computer to execute corresponding processes implemented by the UE/BS in each of the methods of the embodiment of the present application. For brevity, details will not be described herein again.

The embodiment of the present application further provides a computer program. The computer program enables a computer to execute corresponding processes implemented by the UE/BS in each of the methods of the embodiment of the present application. For brevity, details will not be described herein again.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A coverage enhancement method, performed by a user equipment (UE), the method comprising:
transmitting multiple Physical Random Access Channel (PRACH) transmissions at RACH occasions (ROs), wherein Synchronization Signal Blocks (SSBs) are mapped to one or more continuous or non-continuous ROs.

2. The method of claim 1, wherein the SSB maps to continuous or non-continuous ROs, and the SSB is associated to one or more ROs in the time domain.

3. The method of claim 2, wherein the SSB maps to the ROs with same frequency resources and different time domain resources and spans all the time domain resources within a PRACH periodicity.

4. (canceled)

5. The method of claim 1, wherein the continuous ROs means the ROs are on different time instances and all the ROs are valid or available.

6-15. (canceled)

16. The method of claim 1, further comprising:
being configured with one or more random access response (RAR) windows for monitoring RAR message based on one or more Random Access Radio Network Temporary Identifier (RA-RNTI) from a base station when the multiple PRACH transmissions with the same or multiple beams for RACH are enabled.

17-21. (canceled)

22. The method of claim 16, wherein RA-RNTI is determined based on a first RO or a first actual RO or last RO or last actual RO within the multiple PRACH transmissions.

23. (canceled)

24. A coverage enhancement method, performed by base station (BS), the method comprising:
receiving from a user equipment (UE) multiple Physical Random Access Channel (PRACH) transmissions at RACH occasions (ROs), wherein Synchronization Signal Blocks (SSBs) are mapped to one or more continuous or non-continuous ROs.

25. The method of claim 24, wherein the SSB maps to continuous or non-continuous ROs, and the SSB is associated to one or more ROs in the time domain.

26. The method of claim 25, wherein the SSB maps to the ROs with same frequency resources and different time domain resources and spans all the time domain resources within a PRACH periodicity.

27. (canceled)

28. The method of claim 24, wherein the continuous ROs means the ROs are on different time instances and all the ROs are valid or available.

29-38. (canceled)

39. The method of claim 24, further comprising:
configuring a UE with one or more random access response (RAR) windows for monitoring RAR message based on one or more Random Access Radio Network Temporary Identifier (RA-RNTI) when the multiple PRACH transmissions with the same or multiple beams for RACH are enabled.

40-44. (canceled)

45. The method of claim 39, wherein RA-RNTI is determined based on a first RO or a first actual RO or last RO or last actual RO within the multiple PRACH transmissions.

46. (canceled)

47. A user equipment (UE), comprising a processor, configured to call and run program instructions stored in a memory, to execute transmitting multiple Physical Random Access Channel (PRACH) transmissions at RACH occasions (ROs), wherein Synchronization Signal Blocks (SSBs) are mapped to one or more continuous or non-continuous ROs.

48. (canceled)

49. The method of claim 1, wherein the SSB maps to ROs with same frequency resources and different time domain resources and spans all the time domain resources within a PRACH periodicity.

50. The method of claim 24, wherein the SSB maps to ROs with same frequency resources and different time domain resources and spans all the time domain resources within a PRACH periodicity.

51. The UE of claim 47, wherein the SSB maps to continuous or non-continuous ROs, and the SSB is associated to one or more ROs in the time domain.

52. The UE of claim 47, wherein the SSB maps to ROs with same frequency resources and different time domain resources and spans all the time domain resources within a PRACH periodicity.

53. The UE of claim 47, wherein the continuous ROs means the ROs are on different time instances and all the ROs are valid or available.

54. The UE of claim 47, wherein the UE is configured with one or more random access response (RAR) windows for monitoring RAR message based on one or more Random Access Radio Network Temporary Identifier (RA-RNTI) from a base station when the multiple PRACH transmissions with the same or multiple beams for RACH are enabled.

55. The UE of claim 54, wherein RA-RNTI is determined based on a first RO or a first actual RO or last RO or last actual RO within the multiple PRACH transmissions.
